(19) United States
(12) Patent Application Publication
(10) Pub. No.: US 2020/0344854 A1
(43) Pub. Date: Oct. 29, 2020

(54) LIGHTING DEVICE CONTROLLING CIRCUIT AND LIGHTING SYSTEM

(71) Applicant: XIAMEN ECO LIGHTING CO. LTD., Xiamen (CN)

(72) Inventor: Xiaojun Tang, Xiamen (CN)

(21) Appl. No.: 16/398,196

(22) Filed: Apr. 29, 2019

(51) Int. Cl. H05B 37/02

(52) U.S. Cl. CPC H05B 37/0209

(57) ABSTRACT

A lighting device controlling circuit includes: a first switching module arranged to receive a button signal, wherein the first switching module is selectively opened or closed according to the button signal; a signal processing module coupled to the first switching module for processing the button signal to generate an adjusting signal; and a power converting module coupled to the signal processing module for changing an illuminating mode of a lighting device according to the adjusting signal.

### BACKGROUND

Conventionally, the luminance of a lighting device may be controlled by a control circuit, in which the control circuit generates a control signal to adjust the luminance of the lighting device. One of the challenges in this field is to provide a lighting device with wide adjustment range and stable illuminating state.

Conventionally, a remote control, an external sensor, or an application (APP) may be applied to control the luminance of a lighting device. For the example of the conventional APP, a user of the mobile device sends commands to the lighting device through the APP on the mobile device for changing the illuminating parameters as well as the luminance of the lighting device. However, this method may need to incorporate additional sensing device and/or related software to the control device that may increase the complexity of the hardware and operating steps of the control device. Moreover, the cost of the control device is also increased by the complex design and complex operating steps of the control device.

### SUMMARY

The present invention relates to a lighting system, and more particularly to a lighting device controlling circuit for controlling illuminating modes of a lighting device.

Embodiments of the present invention provide a lighting device controlling circuit. The lighting device controlling circuit comprises a first switching module, a signal processing module, and a power converting module. The first switching module is arranged to receive a button signal, wherein the first switching module is selectively opened or closed according to the button signal. The signal processing module is coupled to the first switching module for processing the button signal to generate an adjusting signal. The power converting module is coupled to the signal processing module, for changing an illuminating mode of a lighting device according to the adjusting signal.

In one embodiment of the lighting device controlling circuit, the lighting device is powered on when the first switching module is closed, the lighting device is powered off when the first switching module is opened.

In one embodiment of the lighting device controlling circuit, the power converting module has a power inputting terminal coupled to the first switching module for receiving a supply power, a signal inputting terminal coupled to the signal processing module for receiving the adjusting signal, and a power output terminal coupled to the lighting device, wherein the power converting module transfer the supply power to the lighting device when the first switching module is closed.

In one embodiment of the lighting device controlling circuit, the button signal comprises a number of triggering signals continuously triggered on the first switching module, and the signal processing module is arranged to count the number of the triggering signals, and to generate the adjusting signal according to the number of the triggering signals.

In one embodiment of the lighting device controlling circuit, the supply power is domestic power transmitted through a live wire and a neutral wire.

In one embodiment of the lighting device controlling circuit, the first switching module is coupled between the live wire and the power inputting terminal of the power converting module, or the first switching module is coupled between the neutral wire and the power inputting terminal of the power converting module.

In one embodiment of the lighting device controlling circuit, the lighting device controlling circuit further comprises a second switching module. The first switching module is coupled between the live wire and the power inputting terminal of the power converting module, and the second switching module is coupled between the neutral wire and the power inputting terminal and the power converting module.

In one embodiment of the lighting device controlling circuit, the signal processing module the lighting device is powered on when the first switching module and the second switching module are closed, and the lighting device is powered off when one of the first switching module and the second switching module is opened.

In one embodiment of the lighting device controlling circuit, the button signal comprises a number of triggering signals continuously triggered on the first switching module, and the signal processing module comprises a signal detecting unit and a signal converting unit. The signal detecting unit is coupled to the first switching module, for counting the number of the triggering signals, and to convert the number into the adjusting signal accordingly. The signal converting unit is coupled between the signal detecting unit and the signal inputting terminal of the power converting module, for converting the adjusting signal into a digital format from an analog format.

In one embodiment of the lighting device controlling circuit, the signal detecting unit comprises: a first diode having an anode and a cathode; a second diode having an anode and a cathode; a first resistor having a first terminal and a second terminal; a second resistor having a first terminal and a second terminal; a third resistor having a first terminal and a second terminal; and a first capacitor having a first terminal and a second terminal. The anode of the first diode is coupled to the switching module, the cathode of the first diode is coupled to the first terminal of the first resistor; the second terminal of the first resistor, the first terminal of the second resistor, the cathode of the second diode, and the first terminal of the first capacitor are coupled to the signal converting unit; the second terminal of the second resistor, the anode of the second diode, and the second terminal of the first capacitor are coupled to a ground.

In one embodiment of the lighting device controlling circuit, the switching module comprises a wall switch. The wall switch is installed on a wall, a first terminal of the wall switch coupled to a power supply, and a second terminal of the wall switch coupled to the signal processing module and the power converting module.

In one embodiment of the lighting device controlling circuit, the illuminating mode of the lighting device comprises a first illuminating mode and a second illuminating mode; the power converting module is arranged to switch the lighting device to selectively operate in the first illuminating mode or the second illuminating mode according to the adjusting signal. A brightness and a light color generated by the lighting device are a first luminance and a first light color during the first illuminating mode respectively, the brightness and the light color generated by the lighting device are a second luminance and a second light color during the second illuminating mode respectively, the second luminance is different from the first luminance, and the second light color is different from the first light color.

Embodiments of the present invention provide a lighting device controlling circuit. The lighting device controlling circuit comprises a switching module, a signal processing module, and a power converting module. The switching module is arranged to receive a number of triggering signals continuously triggered thereon. The signal processing module is coupled to the switching module, for generating an adjusting signal according to the number of triggering signals. The power converting module is coupled to the signal processing module, for controlling an illuminating mode of a lighting device according to the adjusting signal.

In one embodiment of the lighting device controlling circuit, the switching module and the power converting module are coupled to a power supply arranged for providing a supply power, the power converting module transfers the supply power the lighting device when the switching module is closed, and the power converting module does not transfer the supply power the lighting device when the switching module is opened.

In one embodiment of the lighting device controlling circuit, the power converting module further performs a voltage regulating process upon the supply power to generate a regulated supply power for the lighting device.

In one embodiment of the lighting device controlling circuit, the signal processing module is arranged to count the number of the triggering signals, and to generate the adjusting signal in a digital format according to the number.

In one embodiment of the lighting device controlling circuit, the illuminating mode of the lighting device comprises a first illuminating mode and a second illuminating mode, the first illuminating mode and the second illuminating mode correspond to a first number and a second number of the triggering signals respectively. A brightness and a light color generated by the lighting device are a first luminance and a first light color during the first illuminating mode respectively, the brightness and the light color generated by the lighting device are a second luminance and a second light color during the second illuminating mode respectively, the second luminance is different from the first luminance, and the second light color is different from the first light color.

Embodiments of the present invention provide a lighting system. The lighting system comprises a lighting device and a lighting device controlling circuit. The lighting device is arranged to selectively operate under a first illuminating mode or a second illuminating mode. The lighting device controlling circuit is coupled to the lighting device for controlling the lighting device according to a number of triggering signals.

In one embodiment of the lighting device controlling circuit, the lighting device controlling circuit comprises a first switching module a signal processing module, and a power converting module. The first switching module is arranged to receive the number of triggering signals continuously triggered thereon. The signal processing module is coupled to the first switching module for generating an adjusting signal according to the number of triggering signals. The power converting module is coupled to the signal processing module and the power supply for controlling an illuminating mode of a lighting device according to the adjusting signal.

In one embodiment of the lighting device controlling circuit, the first illuminating mode and the second illuminating mode correspond to a first number and a second number of the triggering signals respectively. A brightness and a light color generated by the lighting device are a first luminance and a first light color during the first illuminating mode respectively, the brightness and the light color generated by the lighting device are a second luminance and a second light color during the second illuminating mode respectively, the second luminance is different from the first luminance, and the second light color is different from the first light color.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating a lighting device controlling circuit according to an embodiment of the present invention.

FIG. 2 is a diagram illustrating a lighting device controlling circuit in accordance with another embodiment of the present invention.

FIG. 3 is a diagram illustrating a lighting device controlling circuit in accordance with another embodiment of the present invention.

FIG. 4 is a diagram illustrating a lighting device controlling circuit in accordance with another embodiment of the present invention.

FIG. 5 is a diagram illustrating a signal detecting unit in accordance with an embodiment of the present invention.

FIG. 6 is a diagram illustrating a lighting system in accordance with an embodiment of the present invention.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about”. Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one end point to another end point or between two end points. All ranges disclosed herein are inclusive of the end points, unless specified otherwise.

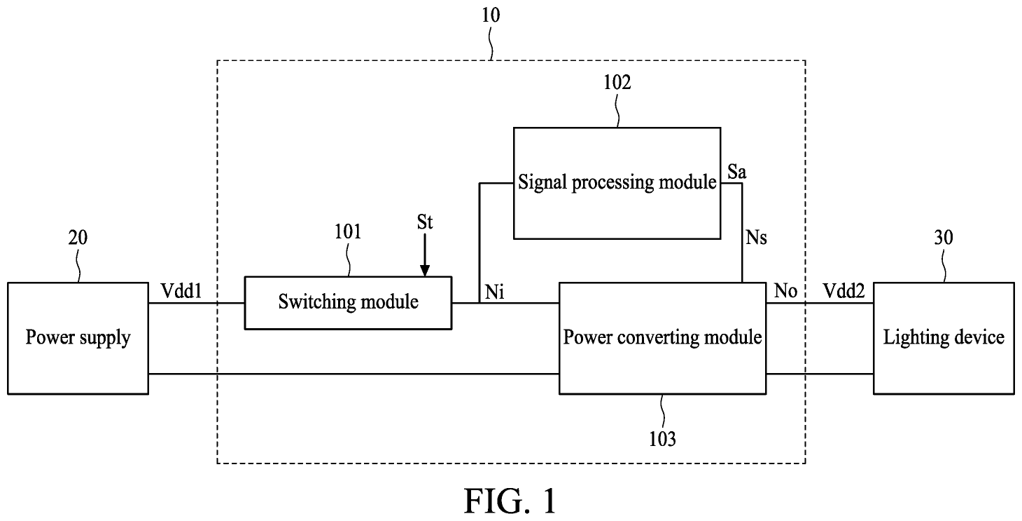

FIG. 1 is a diagram illustrating a lighting device controlling circuit 10 according to an embodiment of the present invention. For the purpose of description, a power supply 20 and a lighting device 30 are also shown in FIG. 1. The illuminating state of the lighting device 30 may be intelligently controlled by the lighting device controlling circuit 10 such that the lighting device 10 may vary the luminance according to the button signal of a button pressed by the user. Therefore, the present lighting device 30 may provide great convenience for the user under different conditions. For brevity, the following paragraphs and figures only illustrate the components related to the related embodiments.

As shown in FIG. 1, the lighting device controlling circuit 10 comprises a switching module 101, a signal processing module 102, and a power converting module 103. The switching module 101 is coupled with the power supply 20. The power converting module 103 is coupled between the power supply 20, the switching module 101, the signal processing module 102, and the lighting device 30. The switching module 101 receives the button command through the button signal. In other words, the switching module 101 may comprise a button for receiving button signal from user. The connectivity of the switching module 101 is selectively closed or opened based on the button command/signal. The button command/signal comprises a button message inputted/transferred from the user. The button command may change the operating condition of the lighting device controlling circuit 10 such that the lighting device 30 may generate different luminous effects. The power supply 20 is arranged to supply electric energy or supply power Vdd1. The electric energy may drive the well-designed electrical components in the lighting device controlling circuit 10 such that the lighting device controlling circuit 10 may steadily control the lighting device 30. The switching module 101 is arranged to open or close the connection between two connecting terminals of the switching module 101. When the switching module 101 is closed, the lighting device controlling circuit 10 receives the electric energy, and the lighting device 30 outputs the corresponding luminance according to the electric energy. On the other hand, when the switching module 101 is opened, the lighting device controlling circuit 10 and the lighting device 30 loss the electric energy, and the lighting device controlling circuit 10 fails to control the luminance of the lighting device 30. Accordingly, in this embodiment, the switching module 101 is capable of controlling on/off of the electric energy of the lighting device controlling circuit 10, which is relatively simpler than the related arts. Moreover, the lighting device controlling circuit 10 also has a relatively high responding speed of the button command. According to some embodiments, a user may externally enter the button command to the switching module 101 such that the lighting device 30 may generate light with luminance required by the user. Accordingly, the lighting device controlling circuit 10 has relatively good operability and better user experience.

According to the embodiment, the button signal of the switching module 101 may comprise a number of triggering signals St continuously triggered on the switching module 101. The signal processing module 102 is coupled with the switching module 101. The signal processing module 102 is arranged to count the number of triggering signals St continuously triggered on the switching module 101, and to generate the adjusting signal Sa according to the counting number. Therefore, the adjusting signal Sa comprises the messages triggered on the switching module 10. The messages of the adjusting signal Sa are arranged to be one-to-one correspond to the different numbers of triggering signals St continuously triggered on the switching module 101. Furthermore, the signal processing module 102 is capable of determining if the switching module 101 is triggered by user. When the switching module 101 is triggered, the state of the switching module 101 is changed, and the lighting device controlling circuit 10 is capable of controlling the lighting device 30 accordingly. For example, every time the switching module 101 is triggered, the state of the switching module 101 is either changed to the disconnecting state from the connecting state, or changed to connecting state from the disconnecting state. When the switching module 101 is triggered continuously, the triggering signals St of the switching module 101 may include the message of function selected by the user such that the lighting device 30 may generate the corresponding color and brightness. When the signal processing module 102 obtains the number of triggering signals St continuously triggered on the switching module 101, the signal processing module 102 generates the corresponding adjusting signal Sa. The adjusting signal Sa is capable of adjust the illuminating state of the lighting device 30. Accordingly, the user may control the lighting device 30 to generate the required color and brightness according to the button message. Therefore, the lighting device controlling circuit 10 may have better user experience.

The power inputting terminal Ni of the power converting module 103 is coupled with the power supply 20 through the switching module 101. The signal inputting terminal Ns of the power converting module 103 is coupled with the signal processing module 102. The power outputting terminal No of the power converting module 103 is coupled with the lighting device 30. When the switching module 101 is closed, the power converting module 103 transfers electric power to the lighting device 30. When the switching module 101 is opened, the power converting module 103 cuts off the electric power of the lighting device 30. Accordingly, in this present embodiment, the power converting module 103 is capable of selectively converting electric power to the lighting device 30 for controlling the illuminating state of the lighting device 30. When the switching module 101 is opened, the power converting module 103 is unable to receive the supply power Vdd1 from the power supply 20, and the lighting device 30 is unable to generate light. When the switching module 101 is closed, the power converting module 103 receives the supply power Vdd1 from the power supply 20, and the power converting module 103 is able to process and convert the supply power Vdd1 for the lighting device 30. For example, the power converting module 103 may perform a filtering process and a voltage regulating process upon the supply power Vdd1, and output the regulated supply power Vdd2 to the lighting device 30 for driving the lighting device 30. Accordingly, the lighting device 30 may steadily operate under the corresponding illuminating state. Therefore, the present embodiment, e.g. the power converting module 103, provides a relatively easy way for user to selectively power-up or power-down the lighting device 30.

The signal processing module 102 is arranged to output the adjusting signal Sa to the signal inputting terminal Ns of the power converting module 103. The power converting module 103 changes the illuminating mode of the lighting device 30 according to the adjusting signal Sa. Accordingly, the brightness and the color of the lighting device 30 may be adjusted. The operating state of the power converting module 103 is changed by the adjusting signal Sa. The relationship between the illuminating mode of the lighting device 30 and the number of signals continuously triggered on the switching module 101 may be obtained through the adjusting signal Sa. The power converting module 103 obtains the light switching information according to the adjusting signal Sa. As the illuminating state of the lighting device 30 may be changed by the adjusting signal Sa, the color and the brightness of the lighting device 30 may be adjusted or changed by user through the adjusting signal Sa. Therefore, the lighting device 30 may be intelligently controlled by the lighting device controlling circuit 10.

In addition, the power converting module 103 may comprise a microcontroller and a rectifying circuit. For example, the microcontroller may be included in MCS-51 microcontroller family, wherein the microcontroller may analyze and process the adjusting signal Sa such that the lighting device 30 may switch among different illuminating modes. The rectifying circuit may comprise a rectifier bridge. When the switching module 10 is closed, the rectifier bridge may rectify the power supply such that the lighting device 30 may receive a stable supply power Vdd2. Accordingly, the lighting device controlling circuit 10 is not only structurally simple and low cost, and the lighting device controlling circuit 10 also increase the stability and safety of the lighting device 30.

In this embodiment, the lighting device controlling circuit 10 receives the button message of user through the switching module 101 for changing the luminous effects of the lighting device 30. Therefore, the lighting device controlling circuit 10 improves the interaction between human and machine through the button message. Without using additional sensor or software, the lighting device controlling circuit 10 may intelligently control the lighting device 30. The lighting device controlling circuit 10 may greatly simplify the luminous control of the lighting device 30. The lighting device controlling circuit 10 changes the illuminating mode of the lighting device 30 through the power converting module 103 for improving the user experience. In this embodiment, the lighting device controlling circuit 10 has a relatively high responding speed of controlling the lighting device 30 and a relatively low manufacturing cost. In comparison the related arts, which have the complex design and complex operating steps, the illuminating state of the lighting device 30 is more easily to be controlled by using the present lighting device controlling circuit 10.

In one embodiment, the power supply 20 is domestic power. The domestic power may be the general-purpose alternating-current (AC) electric power supply. The electrical power of the domestic power is delivered to homes and businesses. The voltage and frequency of the domestic power differ between regions. For example, a voltage of 230 V and a frequency of 50 Hz are used in Europe. In North America, the most common combination is 120 V and a frequency of 60 Hz.

In another embodiment, the power supply 20 is direct current (DC) power. The voltage level of the DC power may be any voltage falling within the range 160V-220V.

When the power supply 20 is the domestic power, the lighting device controlling circuit 10 may receive the domestic power, and the power converting module 103 may convert the electric power of the domestic power into a stable output power. The power converting module 103 may output the stable output power to the lighting device 30 for steadily driving the lighting device 30. The lighting device controlling circuit 10 may change the illuminating mode of the lighting device 30. Therefore, the manipulation of the lighting device controlling circuit is improved. In this embodiment, the lighting device controlling circuit 10 may be applied in various industrial fields due to its great compatibility.

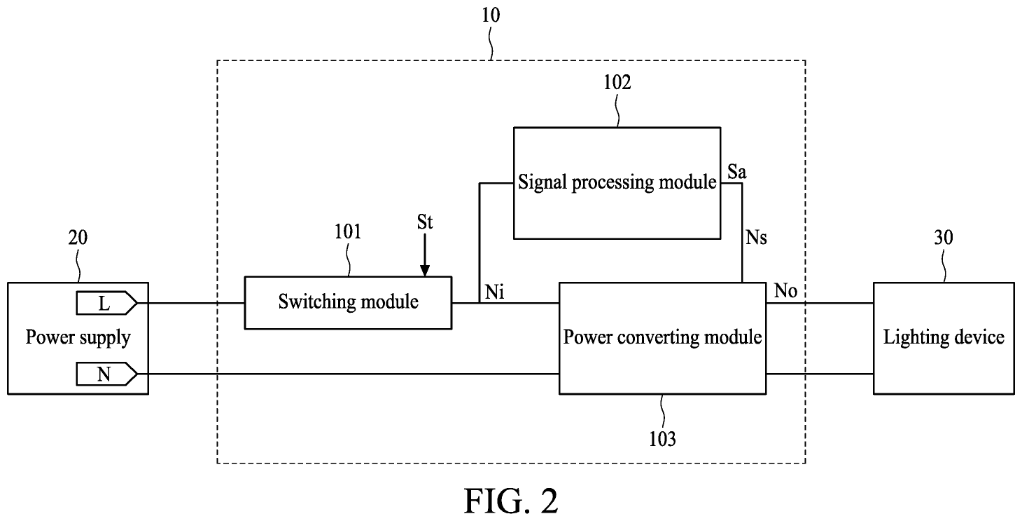

FIG. 2 is a diagram illustrating a lighting device controlling circuit 10 in accordance with another embodiment of the present invention. For the purpose of description, a power supply 20 (i.e. the domestic power) and a lighting device 30 are also shown in FIG. 2. In FIG. 2, the domestic power comprises a live wire L and a neutral wire N. For brevity, FIG. 2 has the numeral elements similar to FIG. 1.

The switching module 101 is coupled between the live wire L and the power inputting terminal of the power converting module 103. However, this is not a limitation of the present invention. In another embodiment, the switching module 101 may be coupled between the neutral wire N and the power inputting terminal of the power converting module 103.

The switching module 101 may change the state of the power inputting to the lighting device controlling circuit 10 such that the lighting device controlling circuit 10 selectively provide power to the lighting device 30. In this embodiment, the live wire L and the neutral wire N are configured to be able to provide the corresponding supply power Vdd1. The switching module 101 may be coupled to the power transmitting line in the live wire L. The switching module 101 may also be coupled to the power transmitting line in the live wire N in another embodiment. The switching module 101 may open or close the connection between the live wire L and the power converting module 103. Accordingly, in this embodiment, the circuit structure of the switching module 101 is more compatible to other system and has better user experience. Therefore, the lighting device controlling circuit 10 may be applied in various application fields.

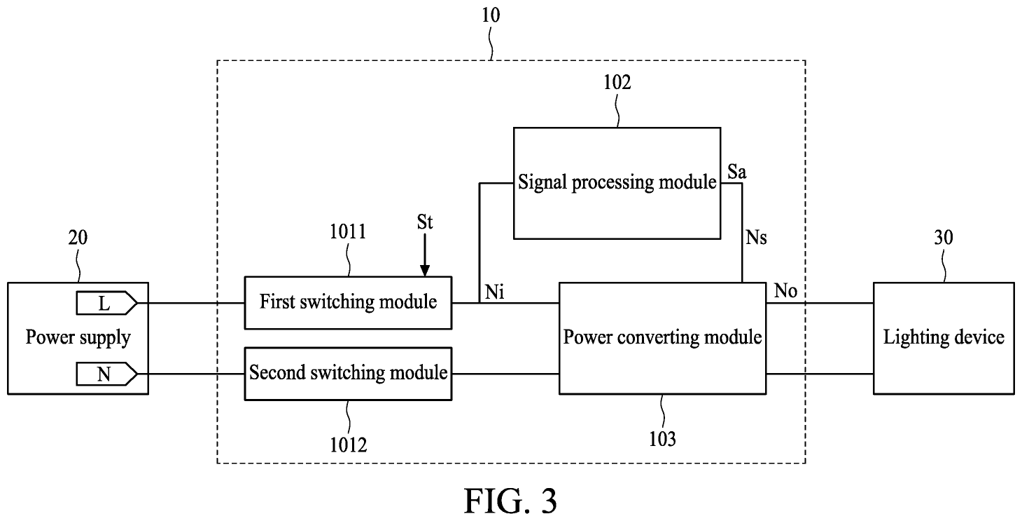

In another embodiment as shown in FIG. 3, which is a diagram illustrating a lighting device controlling circuit 10 in accordance with an embodiment of the present invention. In FIG. 3, the domestic power comprises a live wire L and a neutral wire N, and the lighting device controlling circuit 10 comprises two switching modules 1011 and 1012. For the purpose of description, a power supply 20 (i.e. the domestic power) and a lighting device 30 are also shown in FIG. 3. For brevity, FIG. 3 has the numeral elements similar to FIG. 1.

The first switching module 1011 is connected between the live wire L and the power inputting terminal of the power converting module 103. The second switching module 1012 is connected between the neutral wire N and the power inputting terminal of the power converting module 103.

In this embodiment, the connectivity of the lighting device controlling circuit 10 is implemented by the switching modules 1011 and 1012. Specifically, the power inputting terminal Ni of the power converting module 103 may conduct the supply power Vdd1 to the lighting device 30 only when both of the first switching module 1011 connected to the power transmitting line of the live wire L and the second switching module 1012 connected to the power transmitting line of the neutral wire N are closed. Therefore, when both of the switching modules 1011 and 1012 are closed, the lighting device 30 may generate light and change the illuminating state. If one of the switching module 1011 and the switching module 1012 connected to the power transmitting line of the neutral wire N is opened, the lighting device 30 may loss the electric energy. Accordingly, in this embodiment, the two switching modules 1011 and 1012 may guarantee the stability of the lighting device controlling circuit 10. Moreover, the two switching modules 1011 and 1012 may protect the lighting device 30 from the external interference signal such that the lighting device 30 may have stable illuminating state. Accordingly, the controlling performance of the lighting device controlling circuit 10 is increased, and the illuminating error of the lighting device 30 is reduced.

In another embodiment, the power converting module 103 switches the illuminating mode of the lighting device 30 according to the adjusting signal Sa. The following paragraphs describe the detailed operation of this embodiment.

The power converting module 103 is arranged to obtain the relationship between the illuminating state of the lighting device 30 and the number of triggering signals continuously triggered on the switching module 101 as well as 1011 according to the adjusting signal Sa. The power converting module 103 is arranged to switch the illuminating mode of the lighting device 30 according to the obtained relationship.

As mentioned in the above paragraph, the number of triggering signals continuously triggered on the switching module 101 as well as 1011 corresponds to the function selected by user. For example, the power converting module 103 may control the lighting device 30 to have different illuminating modes (e.g. different color and brightness) when the continuous triggering numbers on the switching module 101 are three and four respectively. Accordingly, the power converting module 103 may obtain the illuminating state of the lighting device 30 through the adjusting signal Sa. Then, the power converting module 103 may obtain the command of switching operation according to the relationship. The power converting module 103 is arranged to adjust the light color and brightness of the lighting device 30 according to the relationship. Accordingly, the lighting device controlling circuit 10 may achieve good controlling performance through the power converting module 103. In this embodiment, the lighting device controlling circuit 10 may switch the illuminating mode of the lighting device 30 in real time.

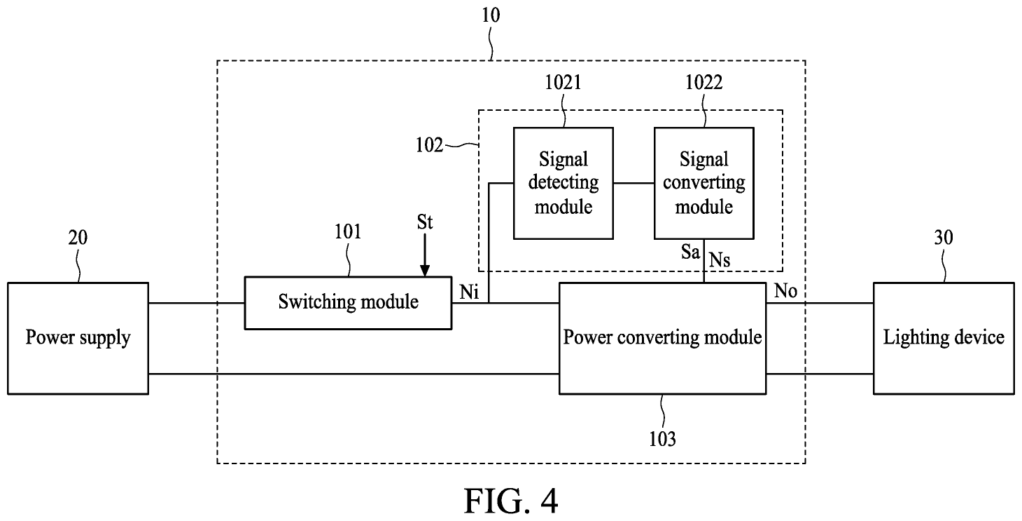

In another embodiment as shown in FIG. 4, which is a diagram illustrating a lighting device controlling circuit 10 in accordance with an embodiment of the present invention, the signal processing module 102 comprises a signal detecting unit 1021 and a signal converting unit 1022. For the purpose of description, a power supply 20 and a lighting device 30 are also shown in FIG. 4. For brevity, FIG. 4 has the numeral elements similar to FIG. 1.

The signal detecting unit 1021 is coupled with the switching module 101. The signal detecting unit 1021 is arranged to count the number of triggering signals continuously triggered on the switching module 101, and to convert the number into the adjusting signal Sa accordingly.

The signal converting unit 1022 is coupled between the signal detecting unit 1021 and the signal inputting terminal of the power converting module 103. The signal converting unit 1022 is arranged to convert the adjusting signal Sa into a digital format from an analog format.

In this embodiment, the signal detecting unit 1021 is arranged to have the function of sampling signal. The signal detecting unit 1021 is capable of detecting if the switching module 101 is triggered. When the switching module 101 is triggered, the operating state of the lighting device controlling circuit 10 is changed accordingly. The signal detecting unit 1021 is capable of detect and store the number of triggering signals continuously triggered on the switching module 101, and to generate the adjusting signal Sa corresponding to the triggering number. In other words, the selected function of user may be obtained from the adjusting signal Sa. Accordingly, the lighting device controlling circuit 10 may accurately control the lighting device 10 through the adjusting signal Sa.

The signal converting unit 1022 is capable of converting signal between analog signal and digital signal. When the adjusting signal Sa is outputted by the signal detecting unit 1021, the power converting module 103 is unable to read or identify the adjusting signal Sa. The signal converting unit 1022 is arranged to convert the adjusting signal Sa into the digital signal from the analog signal. When the power converting module 103 receives the adjusting signal Sa in digital format, the power converting module 103 may directly receive the message of the selected function from user. The signal converting unit 1022 is capable of preventing the adjusting signal Sa from distortion and losing power during the transmission process. Accordingly, the efficiency of signal transmission of the lighting device controlling circuit 10 is improved. Moreover, the adjusting signal Sa may timely drive the power converting module 103 for changing the illuminating mode of the lighting device 30. Therefore, the responding speed of the lighting device controlling circuit 10 is increased such that the lighting device controlling circuit 10 may always operate under a stable state.

It should be noted that, in this embodiment, the signal converting unit 1022 may be implemented by an analog-to-digital converter (ADC). For example, the ADC may comprise: at least one switch, at least one comparator, and other electronic units. The ADC is arranged to convert an analog signal into a digital value for protecting the transmitting quality of the adjusting signal Sa. Accordingly, the lighting device controlling circuit 10 is capable of controlling the illuminating state of the lighting device 30. The lighting device controlling circuit 10 also has great compatible performance.

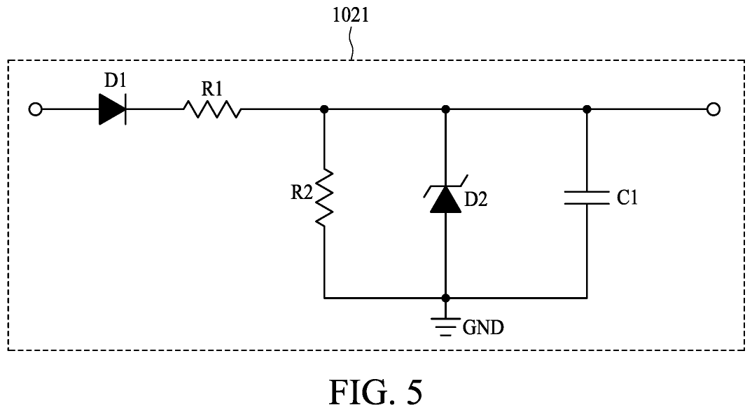

In another embodiment as shown in FIG. 5, which is a diagram illustrating the signal detecting unit 1021 in accordance with an embodiment of the present invention, the signal detecting unit 1021 comprises: a first diode D1, a second diode D2, a first resistor R1, a second resistor R2, a third resistor R3, and a first capacitor C1.

The anode of the first diode D1 is connected to the switching module 101. The cathode of the first diode D1 is connected to the first terminal of the first resistor R1. The second terminal of the first resistor R1, the first terminal of the second resistor R2, the cathode of the second diode D2, and the first terminal of the first capacitor C1 are connected with the signal converting unit 1022. The second terminal of the second resistor R2, the anode of the second diode D2, and the second terminal of the first capacitor C1 are connect to the ground GND.

In FIG. 5, the circuit structure of the signal detecting unit 1021 is shown. The first resistor R1 has the function of limiting current to guarantee the safety of the electronic components in the lighting device controlling circuit 10. The second diode D2 has the function of regulating voltage such that the signal converting unit 1022 may output a stable adjusting signal Sa. When the signal detecting unit 1021 obtains the number of triggering signals continuously triggered on the switching module 101, the signal converting unit 1022 generates adjusting signal Sa accordingly. Then, the signal converting unit 1022 outputs the adjusting signal Sa to the power converting module 103. Therefore, the signal detecting unit 1021 monitors the operation of the switching module 101 in real time. It is noted that the signal detecting unit 1021 may output the number of triggering signals to the signal converting unit 1022 in the form of an electrical signal, e.g. a voltage level. By using the adjusting signal Sa, the lighting device controlling circuit 10 may intelligently adjust the color and brightness of the lighting device 30. Accordingly, in this embodiment, the signal detecting unit 1021 has relatively simple structure, low cost, and great compatible performance. Moreover, the lighting device controlling circuit 10 may also have good control sensitivity upon the lighting device 30.

In another embodiment, the switching module 101 comprises a wall switch. The wall switch is installed on a wall. A terminal of the wall switch is connected with the power supply 20, and the other end of the wall switch is connected to the signal processing module 102 and the power converting module 103.

In another embodiment, the wall switch is BK02 switch. However, this is not a limitation of the present invention. A person skill in the art may use another wall switch model to control the open/close between the power supply 20 and the power converting module 103. Accordingly, the lighting device controlling circuit 10 has good compatible performance.

The wall switch has relatively low manufacturing cost and wide application field. The wall switch also has long lifetime. In this embodiment, the wall switch may receive the button message or button signal from user in real time. The lighting device controlling circuit 10 may change the light function according to the number of triggering signals continuously touched on the wall switch by user. Accordingly, the wall switch may improve the interaction between user and machine. The lighting device controlling circuit 10 may change the illuminating mode of the lighting device 30 in real time, and the user experience is improved. The lighting device controlling circuit 10 also has low manufacturing cost and low application cost. The operation of the lighting device 30 is relatively simple and the lighting device 30 is more compatible to other system.

In an embodiment, the illuminating mode of the lighting device 30 comprises a first illuminating mode and a second illuminating mode. The operation of the power converting module 103 is selectively switching between the first illuminating mode and the second illuminating mode according to the adjusting signal Sa.

When the power converting module 103 is operated under the first illuminating mode, the luminance of the lighting device 30 is the first luminance and the color of the lighting device 30 is the first light color. When the power converting module 103 is operated under the second illuminating mode, the luminance of the lighting device 30 is the second luminance and the color of the lighting device 30 is the second light color. The second luminance and the second light color are different from the first luminance and the first light color respectively.

In this embodiment, the power converting module switches the illuminating mode of the lighting device 30 according to the adjusting signal Sa. The lighting device 30 has different brightness and different colors under different illuminating modes. For example, the first light color is red color and the second light color is blue color. The first luminance is 120 candela (cd) and the second luminance is 150 candela. For example, when the power converting module 103 receives the adjusting signal Sa, the power converting module 103 may control the lighting device 30 to enter the second illuminating mode from the first illuminating mode, or to enter the first illuminating mode from the second illuminating mode. Accordingly, by using the adjusting signal Sa, the power converting module 103 may arbitrarily switch or change the illuminating mode of the lighting device 30. The lighting device 30 may produce the corresponding luminous effects according to the button message from user such that the user may feel the good visual experience. Moreover, the luminous effects of the lighting device 30 may be easily controlled by the lighting device controlling circuit 10.

In one embodiment, the lighting device 30 comprises at one light bead. In another embodiment, the lighting device 30 comprises a plurality of serially connected light beads.

In this embodiment, the lighting device controlling circuit 10 is capable of changing the luminous effects of the plurality of light beads at the same time for increasing the controlling efficiency of the lighting device controlling circuit 10. Accordingly, the cost of controlling the lighting device 30 is reduced. Moreover, the number of the light beads of the lighting device 30 may be arbitrary decided by user. Therefore, the lighting device controlling circuit 10 may be applied in various industrial fields.

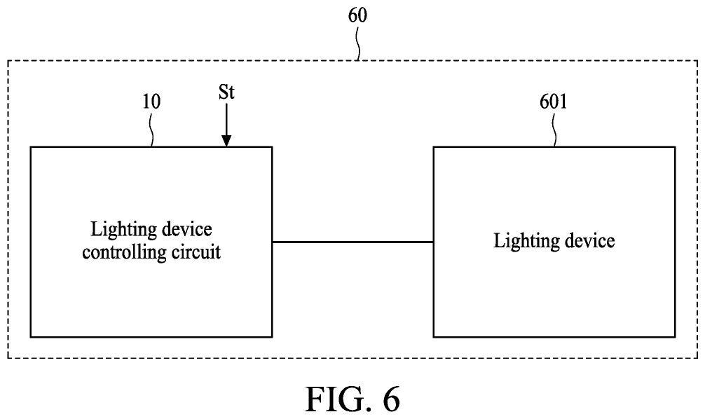

FIG. 6 is a diagram illustrating a lighting system 60 in accordance with an embodiment of the present invention. In FIG. 6, the lighting system 60 comprises a lighting device 601 and the above mentioned lighting device controlling circuit 10. The lighting device 601 is connected with the lighting device controlling circuit 10. The lighting device controlling circuit 10 is arranged to switch the illuminating mode of the lighting device 30 according to the button command.

According to the embodiments as shown in FIG. 1 to FIG. 5, the lighting device controlling circuit 10 is capable of receiving the button message or button signal from user in real time, and the lighting device controlling circuit 10 is capable of switching the illuminating mode of the lighting device 601 according to the button message in real time. Therefore, the illuminating state of the lighting device 601 may be changed by the user through the button message. The operation of this function is relatively easy and has better user experience. The lighting device controlling circuit 10 also has better controlling performance, lower manufacturing cost, and lower application cost. The illuminating state of the lighting device 30 may be intelligently controlled. Accordingly, in this embodiment, the lighting system 60 has great compatibility. In comparison the conventional lighting system, which has high cost and complex operating steps, the lighting system 60 is relatively easily to be controlled and has low cost.

Briefly, in the present embodiments, the lighting device controlling circuit has relatively simple circuit structure and great compatibility. The lighting device controlling circuit is capable of intelligently control the illuminating mode of the lighting device according the button message from user. Therefore, the lighting device may generate light with suitable brightness and color according to the user's requirement. The operation of the lighting device controlling circuit is relatively easy and has lower manufacturing and application cost, which provides great convenience for the user under different conditions. In addition, the lighting device controlling circuit may be applied in various industrial fields due to its great compatibility.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A lighting device controlling circuit, comprising:
a first switching module, arranged to receive a button signal, wherein the first switching module is selectively opened or closed according to the button signal;
a signal processing module, coupled to the first switching module, for processing the button signal to generate an adjusting signal;
a power converting module, coupled to the signal processing module, for changing an illuminating mode of a lighting device according to the adjusting signal; and
a second switching module, wherein the first switching module is coupled between a live wire and a power inputting terminal of the power converting module, and the second switching module is coupled between a neutral wire and a power inputting terminal and the power converting module, wherein the signal processing module the lighting device is powered on when the first switching module and the second switching module are closed, and the lighting device is powered off when one of the first switching module and the second switching module is opened.

2. The lighting device controlling circuit of claim 1, wherein the lighting device is powered on when the first switching module is closed, the lighting device is powered off when the first switching module is opened.

3. The lighting device controlling circuit of claim 1, wherein the power converting module has a power inputting terminal coupled to the first switching module for receiving a supply power, a signal inputting terminal coupled to the signal processing module for receiving the adjusting signal, and a power output terminal coupled to the lighting device, wherein the power converting module transfer the supply power to the lighting device when the first switching module is closed.

4. The lighting device controlling circuit of claim 1, wherein the button signal comprises a number of triggering signals continuously triggered on the first switching module, and the signal processing module is arranged to count the number of the triggering signals, and to generate the adjusting signal according to the number of the triggering signals.

5. The lighting device controlling circuit of claim 1, wherein the supply power is power transmitted through a live wire and a neutral wire.

6. The lighting device controlling circuit of claim 5, wherein the first switching module is coupled between the live wire and the power inputting terminal of the power converting module, or the first switching module is coupled between the neutral wire and the power inputting terminal of the power converting module.

7. (canceled)

8. (canceled)

9. The lighting device controlling circuit of claim 1, wherein the button signal comprises a number of triggering signals continuously triggered on the first switching module, and the signal processing module comprises:
a signal detecting unit, coupled to the first switching module, for counting the number of the triggering signals, and to convert the number into the adjusting signal accordingly; and
a signal converting unit, coupled between the signal detecting unit and the signal inputting terminal of the power converting module, for converting the adjusting signal into a digital format from an analog format.

10. (canceled)

11. The lighting device controlling circuit of claim 1, wherein the first switching module comprises:
a wall switch, installed on a wall, a first terminal of the wall switch coupled to a power supply, and a second terminal of the wall switch coupled to the signal processing module and the power converting module.

12. The lighting device controlling circuit of claim 1, wherein the illuminating mode of the lighting device comprises a first illuminating mode and a second illuminating mode; the power converting module is arranged to switch the lighting device to selectively operate in the first illuminating mode or the second illuminating mode according to the adjusting signal;
wherein a brightness and a light color generated by the lighting device are a first luminance and a first light color during the first illuminating mode respectively, the brightness and the light color generated by the lighting device are a second luminance and a second light color during the second illuminating mode respectively, the second luminance is different from the first luminance, and the second light color is different from the first light color.

13-20. (canceled)
